(19) United States
(12) Patent Application Publication
(10) Pub. No.: US 2017/0039559 A1
(43) Pub. Date: Feb. 9, 2017

(54) METHODS, SYSTEMS, AND APPARATUSES FOR PAYMENT FULFILLMENT

(71) Applicant: OUTERWALL INC., Bellevue, WA (US)

(72) Inventor: Cord Frieden, Bellevue, WA (US)

(73) Assignee: OUTERWALL INC., Bellevue, WA (US)

(21) Appl. No.: 14/887,502

(22) Filed: Oct. 20, 2015

Related U.S. Application Data
(60) Provisional application No. 62/202,767, filed on Aug. 7, 2015.

(51) Int. Cl. G06Q 20/40; G06Q 20/38

(52) U.S. Cl. CPC G06Q 20/40; G06Q 20/382

(57) ABSTRACT

The present disclosure is directed toward methods, systems, and apparatuses for payment fulfillment. The disclosed embodiments include a payment server that receives a request from an entity (e.g., a business or organization) that wants to make a payment to a consumer. In some embodiments, a consumer can initiate a request for payment from an entity. In one embodiment, the payment server sends a notification to a consumer regarding the payment, and the consumer can respond with preferences for delivery. Based on information received from the consumer's computing device (e.g., mobile phone or computer), the payment server can send fulfillment instructions to a kiosk located within a network of kiosks. The consumer can receive payment in the form of a redeemable voucher at the kiosk after the consumer has verified his or her identity and/or input security information.

### CROSS-REFERENCE TO APPLICATIONS INCORPORATED BY REFERENCE

The present application claims priority to U.S. Provisional Patent Application No. 62/202,767, titled “METHODS, SYSTEMS, AND APPARATUSES FOR PAYMENT FULFILLMENT,” filed Aug. 7, 2015, which is incorporated herein by reference in its entirety. The disclosures of U.S. patent application Ser. No. 11/294,637, titled “METHODS AND SYSTEMS FOR EXCHANGING AND/OR TRANSFERRING VARIOUS FORMS OF VALUE,” filed Dec. 5, 2005; U.S. Pat. No. 8,332,313, titled “METHODS AND SYSTEMS FOR EXCHANGING AND/OR TRANSFERRING VARIOUS FORMS OF VALUE,” filed Jul. 22, 2008; U.S. Pat. No. 8,024,272, titled “METHODS AND SYSTEMS FOR EXCHANGING/TRANSFERRING GIFT CARDS,” filed Apr. 12, 2010; U.S. Pat. No. 8,229,851, titled “METHODS AND SYSTEMS FOR EXCHANGING/TRANSFERRING GIFT CARDS,” filed Aug. 19, 2011; U.S. patent application Ser. No. 13/286,971, titled “GIFT CARD EXCHANGE KIOSKS AND ASSOCIATED METHODS OF USE,” filed Nov. 1, 2011 and U.S. patent application Ser. No. 14/312,393, titled “PREPAID CARD EXCHANGE SYSTEMS AND ASSOCIATED METHODS,” filed Jun. 23, 2014, are incorporated herein by reference in their entireties.

### TECHNICAL FIELD

The present disclosure relates generally to methods, systems, and apparatuses for fulfilling payments to consumers and, more particularly, to implementing payments from entities to consumers through a network of consumer-operated kiosks.

### BACKGROUND

Consumers can readily pay businesses for goods or services. For example, a consumer can walk into a shoe store and give his or her credit card, a check, PAYPAL information, or cash to purchase a new pair of shoes. In contrast, when businesses need to pay consumers, businesses have limited options. For example, a phone company can send a refund check to a consumer who overpaid for a monthly service. Yet, the consumer must wait for the check to arrive in the mail, and the wait time is generally long. Also, sending a check in the mail raises the risk of fraud. Additionally, receiving a check usually requires the inconvenience of taking the check to a bank for cashing or deposit, assuming the consumer has a bank account.

Other options for sending money to consumers can require the exchange of confidential information. For example, a business can ask a consumer for the consumer's bank account information, which poses a security and privacy risk for the consumer. As another example, a consumer can want to be paid in cash to be discreet, but businesses are generally not able to provide a cash service. Also, consumers want to be paid quickly and conveniently.

Systems and methods that overcome the above problems and provide additional benefits are needed. Overall, the examples herein of some prior or related systems and their associated limitations are intended to be illustrative and not exclusive. Other limitations of existing or prior systems will become apparent to those skilled in the art upon reading the following Detailed Description.

### BRIEF DESCRIPTION OF THE DRAWINGS

FIG. 1 is a block diagram illustrating an environment for fulfilling a payment from an entity to a consumer in accordance with one embodiment of the present disclosure.

FIG. 2 illustrates a consumer-usable kiosk configured to fulfill a payment in accordance with one embodiment of the present disclosure.

FIGS. 3A and 3B illustrate a representative consumer application that allows a consumer to manage payments from entities in accordance with one embodiment of the present disclosure.

FIG. 4 illustrates a representative browser interface that allows a consumer to manage and monitor payments from entities in accordance with one embodiment of the present disclosure.

FIG. 5 is a block diagram illustrating the exemplary elements of a payment server in accordance with one embodiment of the present disclosure.

FIG. 6 is a flow diagram of operations performed by a payment server in accordance with one embodiment of the present disclosure.

FIG. 7 is a flow diagram of operations performed by a consumer kiosk interacting with a consumer for payment fulfillment in accordance with one embodiment of the present disclosure.

### DETAILED DESCRIPTION

The present disclosure describes methods, systems, and apparatuses for fulfilling a payment from an entity (e.g., financial institution, non-profit organization, business, person, merchant, corporation, etc.) to a consumer (e.g., a person, an agent of an organization, etc.). The disclosed system can include a consumer-operated kiosk and a payment server (collectively “the payment system”). In some embodiments, a consumer can initiate a request for payment. For example, a consumer can initiate a request for payment from an entity via a consumer-operated kiosk. As another example, a consumer can initiate a request for payment from an entity via a mobile application or web browser on a computing device (e.g., mobile phone, laptop computer, desktop computer, tablet, etc.). After a consumer initiates a request for payment from an entity via a kiosk or a computing device, the kiosk or the computing device sends the request to a payment server. To process and/or authorize payment, the payment server can query a database of the paying entity, or the payment server can process the request locally (e.g., by a local database that stores accounting information for payments). After the payment server authorizes the payment, the payment server can provide the kiosk or the computing device information or instructions for the consumer to receive the payment. For example, if the consumer initiates a payment request using a web browser, the payment server can send a message to the consumer via the web browser that includes a unique code that the consumer can input at the kiosk to receive payment. The message can also include directions to a nearby kiosk.

In other embodiments, an entity (e.g., a payor entity such as an online merchant) can initiate a request to pay a consumer. For example, the Internal Revenue Service (an entity) can send a request to a payment server, and the request will include instructions to pay a consumer for his or her tax refund. The payment server stores this request information, and the payment server can then send a notification to the consumer that his or her tax refund is available at a kiosk. The notification can include a unique code (e.g., numbers, letters, a combination of numbers and letters, etc.) that the consumer can enter at the kiosk to receive payment. When the consumer inputs the unique code into a kiosk via the kiosk interface, the kiosk can query the payment server to confirm the code. If the code is correct, the payment server can send instructions to the kiosk to pay the consumer for his or her tax refund. The kiosk can print a redeemable voucher for the amount of the refund or the kiosk can dispense the amount in cash (e.g., a COINSTAR machine can print a voucher redeemable at a cashier located in a supermarket). In some embodiments, a consumer can confirm receipt of payment via a kiosk interface. In some embodiments, a kiosk can use a video camera or sensor to confirm a payment was received.

In some embodiments, the payment system can also assist entities in distributing refund credits. For example, a consumer can purchase a new jacket with cash at a Nordstrom's department store location in Seattle, Wash., but the consumer can live in New York, N.Y. When the consumer returns to New York, he or she can determine that the jacket is defective, and he or she can ship the jacket to a Nordstrom's store warehouse in order to return the jacket. After receiving the returned jacket, the department store will want to refund the consumer. The department store can send a request to the payment server, where the request includes the consumer's name, consumer's contact information (e.g., email or mobile phone number), and the refund credit amount for returning the jacket. The payment server will transmit an electronic message such as an email or text message to the consumer. The electronic message will notify the consumer that Nordstrom, Inc., the store wants to send a refund credit to the consumer. The electronic message can also include a link with instructional information for receiving the refund credit. For example, the electronic message can include a link for the consumer to download a mobile app or visit a webpage to arrange to receive the refund credit. Additionally, the payment server can identify a consumer-operated kiosk (or a few kiosks) that is close to the consumer (e.g., within 5 miles) and is capable of providing a cash payment equal to the refund credit or capable of printing a redeemable voucher equal to the refund credit. Then, the payment server will send the refund credit and consumer information to the identified kiosk or kiosks. When the consumer arrives at the designated kiosk, the consumer requests to receive the refund credit. The kiosk will ask for the consumer to identify himself or herself (present identification or enter in a code), and the kiosk will dispense cash or print a redeemable voucher for the refund credit. If the kiosk prints a voucher, the consumer can redeem the voucher at local merchant (e.g., a supermarket in which the kiosk is located).

In some embodiments, an entity can use its own system (e.g., website or server) to enable consumers to receive payments at a kiosk. In these embodiments, the entity system can communicate with the payment server. For example, the Internal Revenue Service (IRS, an entity) can provide an option (e.g., button, link, window, or widget) on the IRS website that enables a taxpayer to receive a tax refund payment at a kiosk. After selecting the option, the taxpayer can input identification and contact information (e.g., zip code, email, name, or social security number) and request payment at a kiosk via the IRS website. In response, the IRS system can use an application program interface (API) to invoke the payment system to execute a payment request. For example, the IRS server can pass the taxpayer's payment request, email, and the taxpayer's home zip code to the payment server via the API, and the payment server can then execute the payment process (e.g., send an email to a taxpayer with instructions for the taxpayer to receive a tax refund at a kiosk). Also, in some embodiments, an administrator can determine conditions for when payments are valid (e.g., kiosk locations where a consumer can receive a payment or a period of time when a consumer can receive a payment at a kiosk before the payment expires). For example, the IRS may determine it will only honor payment requests from kiosks located within a taxpayer's home zip code, and/or payment requests at a kiosk within three weeks from the date the consumer requested payment.

Furthermore, one of ordinary skill in the art will appreciate that there are several methods for executing a payment transaction from an entity to a consumer at a kiosk in accordance with the present disclosure. For example, Amazon.com, Inc. (Amazon) can enable consumers to receive refunds or payments at a kiosk. One method to execute such payment is for a consumer to visit Amazon.com and request to receive the payment at a kiosk via a button on Amazon.com (e.g., a consumer toggles a button that states “pay me at a kiosk”). Amazon's server can then use an API to pass the payment request and related consumer contact information (e.g., email address, home address, etc.) to the payment system. The payment system can then send instructions to the consumer (e.g., via email), and the instructions can include kiosk locations where the consumer can receive his or her payment. In some embodiments, the consumer can reply to the instructions with a request to cancel the payment, with the intent to use the payment as a credit on Amazon.com.

Another method to execute a payment is for a consumer to setup the payment request using an Amazon mobile application. For example a consumer can use the Amazon mobile application to request a payment from Amazon at a kiosk. In response, the Amazon mobile application can ask the consumer questions, e.g., “would you like to receive the payment at a kiosk near your home address or another address?” After the consumer answers the questions regarding details of the payment, the Amazon mobile application can pass the answers to Amazon's server via the Internet, and Amazon's server can pass the answers to the payment system via an API. The payment system can store the request and wait to be notified that the consumer has reported to a kiosk and is requesting the payment. The payment server can also notify the consumer (e.g., via email or via sending a message via the Internet to the mobile application) that the consumer can report to a kiosk to receive his or her payment. When the consumer arrives at the kiosk and requests the payment via the kiosk, the payment server will communicate with the kiosk to execute the payment transaction. For example, the payment server can verify the consumer's identity or validate the payment. In some embodiments, the payment server can report results (e.g., when and where a payment was processed) to Amazon or another entity. In general, an administrator of the payment server can communicate with Amazon to setup details for a payment process (e.g., types of API calls, security protocols).

Some advantages of the disclosed embodiments are closing the logical and physical separation between consumers, entities, and a payment server through which payment transactions are distributed (e.g., the Amazon or IRS network, the Internet). Furthermore, one with ordinary skill in the art can appreciate that the disclosed embodiments enable a single party (e.g., an entity) to obtain information necessary to establish a connection between consumers and a payment server.

In some embodiments, a payment server and consumer-operated kiosk can verify a consumer's identity or validate a payment without directly using a consumer's identity (e.g., without using the consumer's name or photo identification). For example, the payment server can receive instructions from an entity such as Amazon.com, Inc. to pay a consumer $95 related to a special offer or refund. However, Amazon.com, Inc. may not communicate the consumer's name or identity to the payment server; rather, Amazon.com, Inc. can send the payment server a pseudo name for the consumer (e.g., a numerical code, letter sequence, or combination of letters and numbers) and an email address (e.g., only Amazon.com, Inc. knows the consumer's identify, but Amazon.com, Inc. does not share this information). The payment server can then communicate with the consumer only using email to notify the consumer of the $95 payment. Next, the payment server will determine a unique series of questions and answers to authorize the payment. The payment server will send the unique series of questions and answers to the consumer. The consumer can then use the unique information to receive the payment at the consumer-operated kiosk without identifying himself or herself (e.g., the consumer does not need to show his or her photo ID; rather, he or she can just answer a series of questions with predetermined answers).

Also, in some embodiments, a payment server can send a consumer a message containing content (e.g., barcode) with which to identify him or herself. For example, the consumer can receive an email with a barcode or QUICK RESPONSE (QR) code. The consumer can present the barcode or QR code for reading by the kiosk, and after verifying the payment information, the kiosk can then provide cash or a voucher (i.e., not cash) to the consumer. In other embodiments, a mobile device characteristic (e.g., serial number, phone number, SIM card) can be used as an identifier.

In some embodiments, the disclosed payment system can assist a consumer in selling an unused or partially used gift card for cash. For example, a consumer can want to sell an unused gift card. In this example, the consumer can use the methods, systems, and apparatuses described in U.S. patent application Ser. No. 14/312,393, titled “PREPAID CARD EXCHANGE SYSTEMS AND ASSOCIATED METHODS,” filed Jun. 23, 2014, to receive a code or voucher for the value of the unused gift card. The consumer can then use the code or voucher to receive cash for the unused gift card. In some embodiments, consumers can use the payment to recharge or add value to a gift card.

In some embodiments of the disclosed system and method, an entity can establish a relationship with a payment server administrator. For example, the IRS and payment administrator (e.g., an organization or person who controls the payment server) can contractually agree to exchange financial and security information in order to implement a payment fulfillment system. In such an example, the IRS can provide the payment administrator with limited access to information in the IRS's refund and taxpayer database, and the payment administrator in return can pay the taxpayer's refunds. The payment administrator can take a percentage of each payment (e.g., 1%), or it can charge a flat rate for the service to the IRS. Also, in some embodiments, the payment server can charge the consumer a fee (e.g., 1% of the total transaction cost, a monthly service fee, a flat rate, etc.). The disclosed system will provide verification of payment services for any entity and can also provide data regarding the payment transactions. The entity can use the data to determine whether the payment system is financially viable. Also, an entity can require certain security measures. For example, the IRS can require that before a taxpayer receives a refund at a kiosk, the payment server administrator must require two forms of identification (e.g., driver's license and credit card).

Once a contractual relationship is established between an entity and a payment server, an API can be implemented to allow entities to communicate with a payment server. For example, the payment server administrator will provide an API and the relevant libraries, classes, and functions to an entity. If an entity wants to pay a consumer, the entity can call the API and invoke the payment server to pay a specific consumer using the payment server. For example, the IRS can call an API provided by the payment server administrator and invoke that API to pay a specific taxpayer. In such an example, the IRS requests that the payment server arrange payment for a consumer, and the payment server can execute the transaction with the consumer (e.g., via a smartphone).

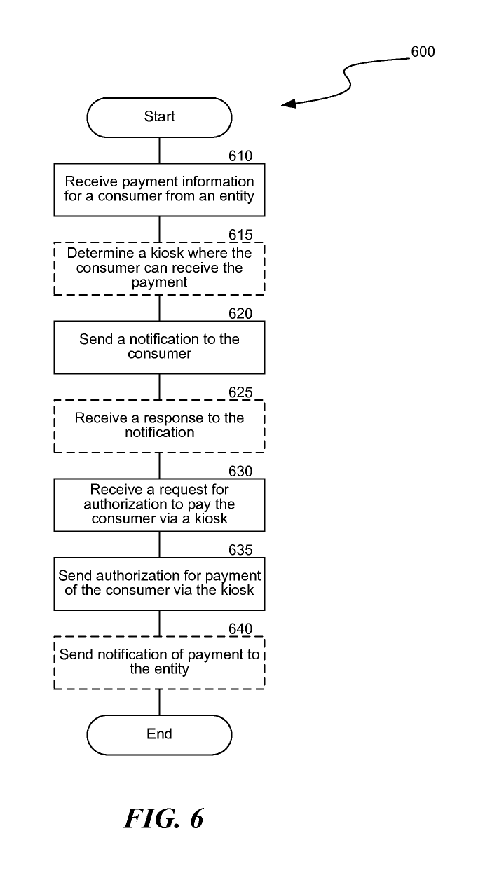

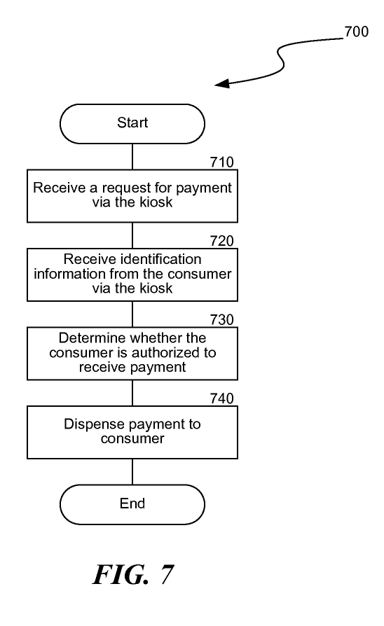

Embodiments of consumer-operated kiosks are described in the section titled “Consumer-operated kiosk”. Embodiments of payment servers are described in the section titled “Payment server”. FIGS. 6 and 7 are example flow diagrams of methods used or executed by the payment system.

Embodiments of the disclosed payment system provide several advantages. First, a consumer can quickly (e.g., within minutes) receive a payment from an entity without visiting the entity's location or waiting for a check. The payment can be cash or a cash voucher redeemable at a location close to the consumer. Second, entities can save on costs for sending and developing infrastructure for a payment system. The disclosed system can handle payments, processing, and overhead costs. Third, kiosks provide flexibility to fulfill payments at various locations and at various times, because kiosks can be located in metropolitan and rural areas. Fourth, unlike regulated banks, the disclosed system is based on a contractual relationship between entities and may not need to meet banking regulations. Fifth, the disclosed system and method provide additional security because consumers may be required to verify their identities in multiple ways (e.g., identification card, mobile phone, validation code), and the disclosed system can include encryption in its electronic communications, which is not available in postal mail. Sixth, the disclosed system improves an architectural network between consumers and entities. Specifically, because of the logical and sometimes physical separation between consumers and entities through which payment transactions are distributed (e.g., the IRS network and the Internet) and the telecommunication networks through which transactions are made (e.g., using a mobile phone or laptop), it can be very difficult for a single party to obtain all information necessary to establish a connection between entities and consumers for payment, but embodiments of the disclosed system can close this information gap.

Various embodiments of the invention will now be described. The following description provides specific details for a thorough understanding and an enabling description of these embodiments. One skilled in the art will understand, however, that the invention can be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

### Illustrative Environment

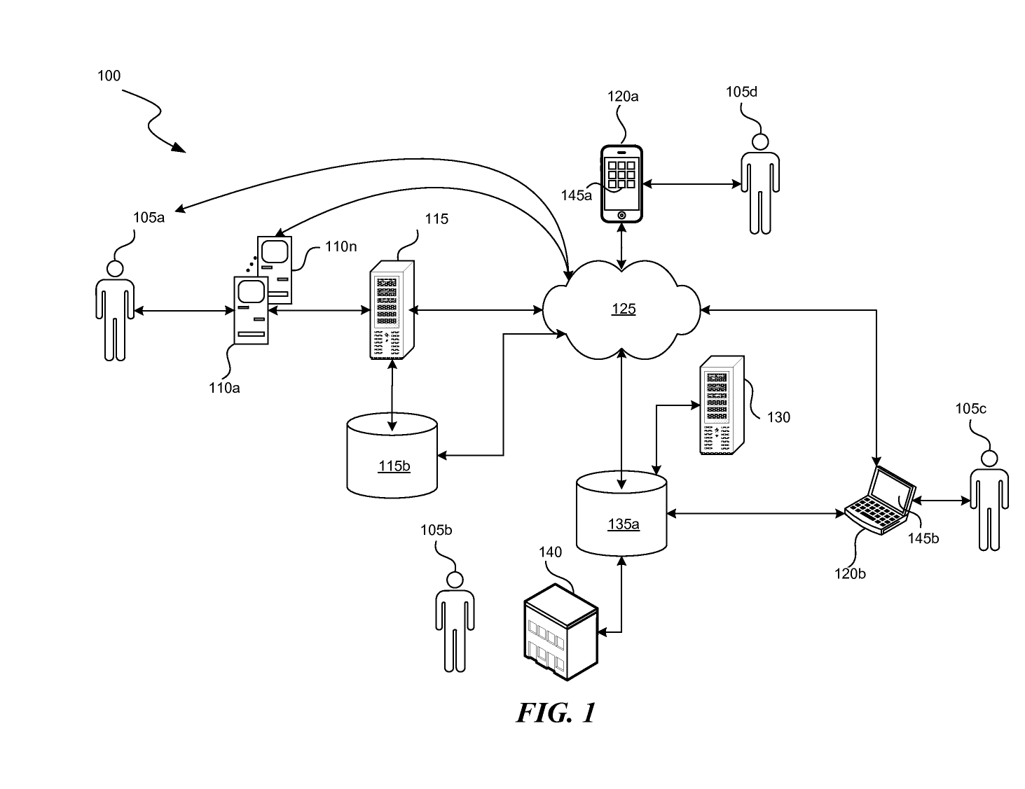

FIG. 1 is a block diagram illustrating an environment 100 for fulfilling a payment from an entity to a consumer. In the environment 100, consumers 105a-d can access kiosk(s) 110a-n for payment fulfilment. Payment server 115 can connect to and communicate data with kiosk(s) 110a-n through a wired or wireless communication link (e.g., 3G or 4G network, antenna, integrated circuit, Wi-Fi chip, cable, etc.). Payment server 115 can connect to and communicate data with payment database 115b, which stores information related to consumers and payments, through a wired or wireless communication link.

Consumers are generally individuals who spend money for services or goods. Consumers can also be individuals who want to receive money from an organization or business. For example, via the disclosed system, NIKE, Inc. can refund a consumer $50 because the consumer returned a pair of running shoes that he or she purchased online. As another example, the IRS can owe a consumer $500 for a tax refund, and consumer 105a can elect to use one of the kiosks 110a-n to receive the refund payment. One with ordinary skill in the art will appreciate that embodiments in this disclosure discuss consumers as individuals, but consumers can also be agents of a consumer, relatives of a consumer, or a business employee. In this document, a single consumer can be consumer 105a and multiple consumers can be consumers 105a-d. Consumer(s) 105a-d is used to mean one or more consumers.

In some embodiments, there can be one kiosk (e.g., 110a) or many kiosks (e.g., 110a-n, where n is the total number of kiosks). One with ordinary skill in the art will appreciate that environment 100 can include several, even thousands of kiosks, located in different locations around the world. The kiosks can be in close proximity to each other or far away from each other. An administrator can determine the proper density of kiosks in a given area in order to determine the best way to provide kiosk access and service. For example, an administrator can place 500 kiosks in downtown Los Angeles, Calif., and 10 kiosks in Malibu, Calif. One with ordinary skill in the art will appreciate other computing devices can be modified to integrate features of the kiosk and thus be used in the environment. In this disclosure, a single kiosk can be kiosk 110a and multiple kiosks can be 110a-n. Kiosk(s) 110a-n means one or more kiosks.

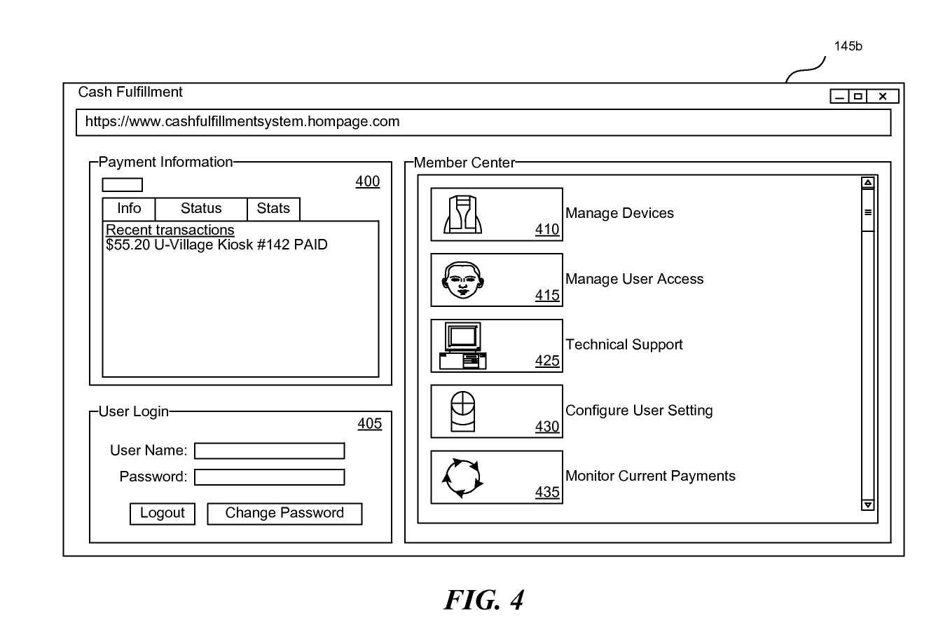

Kiosk(s) 110a-n can connect to and communicate data to payment server 115 through a wired or wireless communication link. Payment server 115 can connect to and communicate data to payment database 115b through a wired or wireless communication link. Payment server 115 can include processor(s), memory, firmware, software, and hardware. Payment server 115 can be accessed over a public network such as the Internet or a private or limited-access network that provides access to one or more gateway providers for processing and routing payments to the appropriate kiosk. Payment server 115 can include application programming interfaces (APIs) as described in FIG. 4.

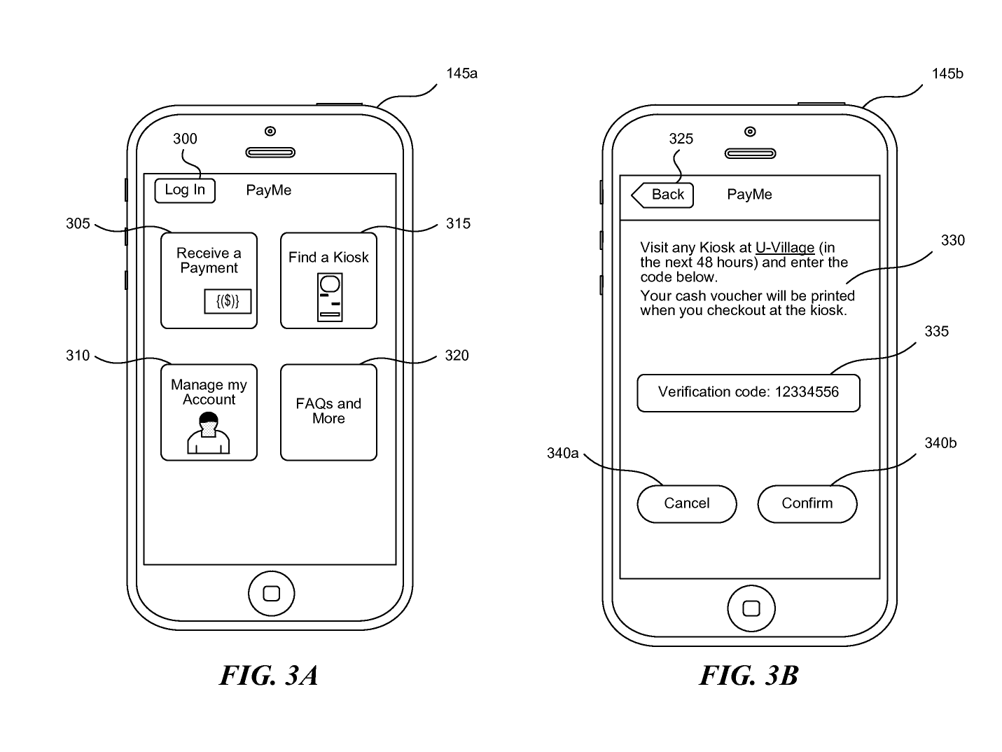

In environment 100, consumers can use computing devices 120a-b (e.g., cell phone(s), smartphone(s), advanced mobile device(s), laptop(s), desktop(s), virtual machine(s), client computer(s), or tablet(s)) to connect to payment server 115, kiosk(s) 110a-n, and entities' hardware and software (“consumer application interface”) 145a-b via the communication network. Computing devices 120a-b include screens (e.g., touchscreens, interfaces). FIGS. 3A-B and 4 include illustrations of example interfaces for computing devices 120a-b.

Communication network 125 allows for communication in environment 100. Communication network 125 can include one or more wireless networks such as, but not limited to, one or more of a Local Area Network (LAN), Wireless Local Area Network (WLAN), a Personal Area Network (PAN), Campus Area Network (CAN), a Metropolitan Area Network (MAN), a Wide Area Network (WAN), a Wireless Wide Area Network (WWAN), Global System for Mobile Communications (GSM), Bluetooth, Wi-Fi, 2G, 2.5G, 3G, 4G, LTE networks, and enhanced data rates for GSM evolution (EDGE). Communication network 125 can also include wired networks. In some embodiments, communication network 125 can be the Internet.

Environment 100 also has entities. The term “entity” generally refers to a company, business, merchant, government agency, or other entity that wants to pay a consumer. For example, the IRS can want to send a tax refund to a taxpayer. While one entity (i.e., entity server 130 and entity database 135a) is shown in FIG. 1, one of ordinary skill in the art will appreciate that there can be several entities (e.g., hundreds or thousands, each with a server or servers and a database or databases). Entities generally have databases (e.g., 135a) and a server 130; and entities can allow payment server 115 or kiosks 110a-n to access these databases (e.g., 135a) and server 130. Entity servers (e.g., 130) store consumer information, and the servers are connected to entity databases (e.g., 135a). Additionally, entities can have a store 140. For instance, a clothing store can want to send a refund to a consumer who recently returned some items at the store but did not have the credit card he or she used to pay for items; thus, without the disclosed system, the consumer would need to receive a check in the mail or provide financial information such as a bank account number or other account information (e.g., PAYPAL account, etc.).

### Consumer-Operated Kiosk

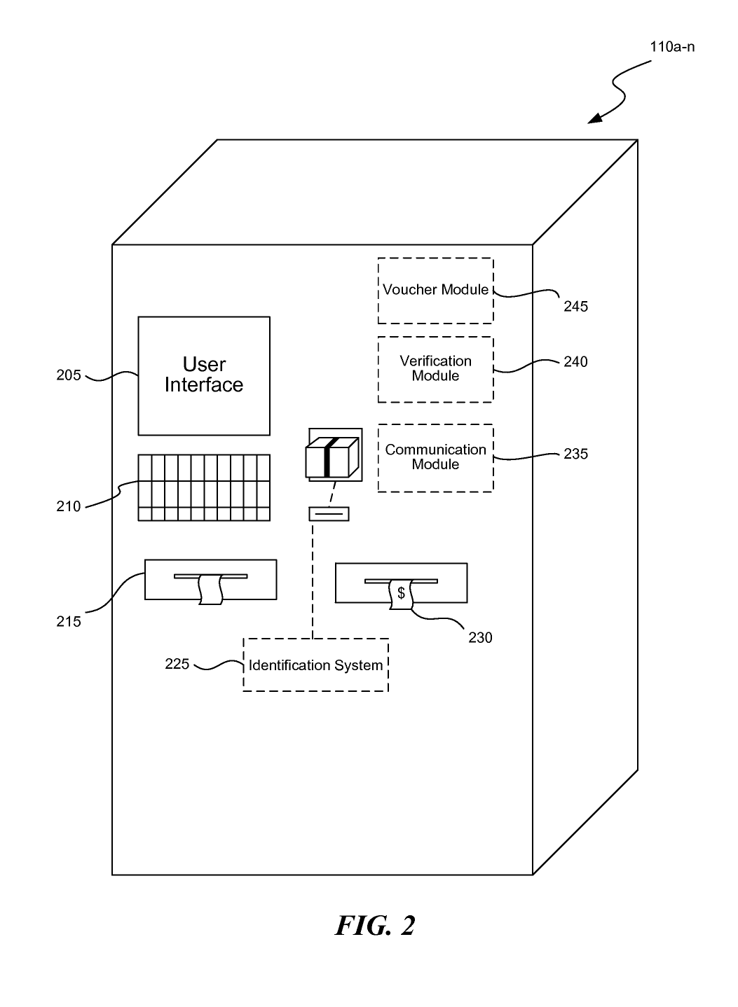

FIG. 2 illustrates a consumer-operated kiosk configured to fulfill a payment to a consumer (e.g., provide a voucher for a refund). A consumer-operated kiosk can include kiosk user interface 205, input area 210 (e.g., keyboard, keypad, a row of buttons), receipt/voucher printer and dispenser 215, identification system 225, cash dispenser 230, communication module 235, verification module 240, and voucher module 245. Various aspects of kiosk(s) 110a-n can be generally similar in structure and function to corresponding features of kiosks and related systems disclosed in U.S. Patent Publication No. 2014/0136351, filed Mar. 8, 2013, titled “CONSUMER OPERATED KIOSKS FOR PURCHASING ITEMS ONLINE AND ASSOCIATED SYSTEMS AND METHODS”; U.S. Pat. No. 7,653,599, filed Feb. 14, 2003, titled “METHODS AND SYSTEMS FOR EXCHANGING AND/OR TRANSFERRING VARIOUS FORMS OF VALUE”; U.S. Pat. No. 8,033,375, filed Feb. 14, 2003, titled “METHODS AND SYSTEMS FOR EXCHANGING AND/OR TRANSFERRING VARIOUS FORMS OF VALUE”; U.S. Pat. No. 8,103,586, filed Dec. 28, 2009, titled “METHODS AND SYSTEMS FOR EXCHANGING AND/OR TRANSFERRING VARIOUS FORMS OF VALUE”; and U.S. Patent Publication No. 2006/0207856, filed Dec. 5, 2005, titled “METHODS AND SYSTEMS FOR EXCHANGING AND/OR TRANSFERRING VARIOUS FORMS OF VALUE”; each of which is incorporated herein by reference in its entirety. While not shown in FIG. 2, a consumer-operated kiosk can include a collection unit (to hold gifts cards or other items) or other storage space or compartments.

The consumer can directly interact with kiosk user interface 205, input area 210, receipt/voucher printer and dispenser 215, identification system 225, and cash dispenser 230. For example, kiosk user interface 205 can present a consumer with a touch screen. In such an example, a consumer can enter an identification code to receive a cash payment from an entity (e.g., buttons on the touch screen including “enter identification,” “pay me now,” etc.). The user interface 205 can also enable the consumer to enter personal information (e.g., telephone number, contact information, email address) in order to register for certain services or accounts (e.g., IRS tax refunds or refunds from merchants). One with ordinary skill in the art will appreciate that kiosk(s) 110a-n can enable consumers to enter information to sign up for an account or service for managing payment information or to link other online services to the consumer. For example, consumer(s) 105a-d can link a PAYPAL account or a bank account to the payment service. In some embodiments, the system can configure a “consumer profile” to store and maintain data about consumers, payments for consumers, and entities linked to consumers. The data can include general information such as title, phone number, photo, biographical summary, and status (e.g., active member). As mentioned below, the data can include entity information. One with ordinary skill in the art will appreciate that receipt/voucher printer and dispenser 215 can be a separate printer and dispenser or a combined printer and dispenser.

Kiosk user interface 205 can include menus, lists, and sliders to assist a consumer in navigating a transaction or signing up for a service. Input area 210 can include a standard QWERTY keyboard or area with special buttons (e.g., numeric keypad, “enter” button, “cancel” button, “call for customer help” button). While not shown in FIG. 2, one with ordinary skill in the art will appreciate that a kiosk can include a microphone, speaker, and other audio equipment in order to communicate with a consumer and for consumer to communicate in response. Furthermore, kiosk(s) 110a-n can include a camera, video camera, or infrared sensor to survey the area near and around the kiosk. Such camera, video camera, or infrared sensor can also be used to enhance communication for consumer with a kiosk. Also, a remotely located customer service representative can be able to communicate with a consumer via the microphone and speaker in a kiosk.

Receipt/voucher printer and dispenser 215 can print different types of documents. For example, receipt/voucher printer and dispenser 215 can print vouchers that can be redeemed at retail stores or banks. Also, entities can restrict where the vouchers are redeemable. For example, the IRS can require that if a consumer receives a voucher at a kiosk, the consumer must redeem the voucher at a particular merchant (e.g., grocery store, bank, etc.). Limiting the merchant or area where the voucher is redeemable can serve security purposes (e.g., an additional requirement to prevent fraud). Also, receipt/voucher printer and dispenser 215 can print receipts that reflect a record of the transaction. For example, if consumer receives cash at kiosk for payment from an entity, consumer can receive a receipt from receipt/voucher printer and dispenser 215 showing a record of the payment. Receipt/voucher printer and dispenser 215 can print documents with coupons, pictures, barcodes, and QR codes. The payment barcode can include one or more of the following: a linear barcode, two-dimensional barcode, three-dimensional barcode, and/or machine-readable code.

Identification system 225 can include several components for consumer identification or verification purposes. For example, identification system 225 can be means for using an electronic payment card configured to identify a consumer (e.g., membership card, smart card, integrated circuit card, magnetic strip card). Identification system 225 can be configured to analyze information stored on one or more debit cards, credit cards, gift cards, loyalty cards, prepaid cards, bank cards, identity cards (e.g., passport, driver's license, social security card), or membership cards (e.g., company membership, merchant membership). The identification system 225 also can be configured to process QR codes or barcodes (e.g., barcode scanner or QR scanner). Cash dispenser 230 can be configured to provide coins, bills, tokens, and other forms of currency. The means for identification system 225 can be a card receive, a magnetic strip reader, an infrared detector, a video camera, a microphone, a finger print or other biometric analyzer (e.g., eye scanner).

In one embodiment, identification system 225 can interact with kiosk user interface 205 to verify the identity of consumer 105a with a zero-knowledge verification system. In general, a zero-knowledge verification system is an interactive proof system based on a challenge-and-response protocol. With this type of system, a person (a “prover,” e.g., a consumer) convinces somebody else (a “verifier,” e.g., a kiosk or a payment server) of their identify for verification purposes, but the person does not need to provide confidential information (e.g., full social security number, photo ID, etc.). A typical round in the protocol consists of a question (challenge) by a verifier and an answer (response) to the question by a prover. At the end of the protocol, the verifier determines whether to accept or reject the verification based on the answer(s) from the prover. In such an embodiment, the kiosk can query a consumer with questions such as: “Where were you born?”, “What are the last four digits of your social security number?”, and “To what city did you travel last?” The identification system 225 can store these challenges and answers to these challenges on the kiosk. For example, when a payment system sends instructions to a kiosk to pay a consumer, the instructions can include the question “Where were you born?” with an answer “Los Angeles.” Also, the kiosk does not need to store the challenges and answers to the challenges. Rather, the kiosk can query the payment server each time a consumer requests to receive a payment. For example, the consumer can input information into a kiosk requesting a payment, the kiosk can then send a query to the payment server, and the payment server can reply with challenges and answers. Then the consumer can respond to the challenges at the kiosk, and the kiosk can verify these challenges locally (at the kiosk). Also, the kiosk can again query the payment server to determine if an answer is a valid response to a challenge. For example, a consumer can want to receive a $55 refund from a merchant. The consumer can go to a kiosk in a network of kiosk(s) 110a-n, and the consumer can input information to request the $55 payment. The kiosk can then send a query to payment server 115 to ask “Is this payment request valid?”. The payment server 115 can respond to the kiosk server “Yes.” Then, the kiosk can present the consumer with stock questions (“When were you born?”) or with questions received from the payment server (“What is your favorite sports team?”). The kiosk can send the answers to this challenge to the payment server to verify the answers are correct, or it can locally store and validate the correct answers (e.g., the kiosk stores challenges and answers in a computer-readable storage medium, and the kiosk can use a processor to execute computer-readable instructions to determine if the challenges and answers are valid). If the challenge response is valid, then the kiosk will provide the consumer with a voucher.

As shown in FIG. 2, the kiosk(s) 110a-n can also include a communication module 235, a verification module 240, and a voucher module 245. These modules can be used to process a payment transaction. Also, these modules can be implemented as executable instructions stored in memory or by specialized logical circuits (e.g., field-programmable gate arrays). These modules can operate in combination or individually, and all can be configured to communicate with payment server 115 directly. For example, identification system 225 can receive a driver's license picture from a consumer, and verification module 240 can determine if the driver's license is valid and if the driver's license picture matches the consumer.

Communication module 235 can communicate information with other kiosk(s) 110a-n, computing devices 120a-c, payment server 115, entity's consumer application interface 145a, stores 140, and payment database 115b. Communication module 235 can comprise any combination of software agents and/or hardware components able to receive and send payment, consumer, and/or verification data. In one embodiment, communication module 235 can receive computer-readable instructions from payment server 115 to pay consumer 105a if consumer 105a properly verifies their identity. In some embodiments, communication module 235 can report a confirmed payment to entity's consumer application interface 145a or payment server 115. Communication module 235 can also report general information about a kiosk such as maintenance needed, technical issues, theft or fraud alerts, temperature of kiosk, and other general conditions that kiosk(s) 110a-n detect. Operation of communication module 235 will be described in additional detail with respect to FIGS. 6 and 7.

Verification module 240 is generally responsible for verifying a consumer's identity or verifying payment information. Verification module 240 can comprise any combination of software agents and/or hardware components able to receive and process verification data. For example, if a consumer scans his credit card into kiosk 110a using identification system 225, verification module 240 will verify that the credit card is authentic with known security procedures (e.g., prompting consumer to enter zip code information or determining the card number has the correct number of digits and is an active card). Operation of verification module 240 will be described in additional detail with respect to FIGS. 6 and 7.

Voucher module 245 is generally responsible for sending instructions to receipt/voucher printer and dispenser 215, communicating with communication module 235, dispensing cash (e.g., bills, coins, or other forms of currency), and printing vouchers. Voucher module 245 can comprise any combination of software agents and/or hardware components able to receive and process voucher or payment data. Voucher module 245 can store information about a voucher to be printed and given to a consumer. For example, voucher module 245 can store a specific bar code or numeric code that is associated with a particular store where consumer(s) 105a-d can redeem the voucher. In other embodiments, voucher module 245 can instruct kiosk to distribute cash to consumer after the verification process is complete. Operation of voucher module 245 will be described in additional detail with respect to FIGS. 6 and 7.

### Interfaces

FIGS. 3A and 3B illustrate a representative consumer application that allows an entity to provide payment to a consumer, who can then accept/redeem the payment with the application and/or monitor the payment in accordance with embodiments of the present disclosure. For example, FIG. 3A shows one embodiment of a home screen displayed by application software that is loaded onto a consumer's computing device (e.g., smartphone) to fulfill payments. In the embodiment shown, the home screen has login button 300, “receive payment” button 305, “manage my account” button 310, “find a kiosk” button 315, and “FAQs” button 320.

In some embodiments, consumer application interface 145a allows a consumer to locate a kiosk. For example, if consumer(s) are aware that an entity wishes to send consumer(s) payment, a consumer can use the “find a kiosk” button 315 to search available kiosks for payment delivery. In some embodiments, payment server 115 can send kiosk information directly to a consumer's computing device. In other embodiments, the consumer's computing device can automatically determine (e.g., using GOOGLEMAPS API or APPLE location services) a consumer's location, and computing device can interface with payment server 115 to determine one or more kiosks where consumer can receive a cash payment.

In FIG. 3B, consumer application interface 145b includes a back button 325, viewing box 330, a verification code 335, a confirm button 340a, and a cancel button 340b. The consumer can open or use consumer application interface 145b on his or her computing device 120a-b. For example, the consumer can download a consumer application, and the consumer application can display the consumer application interface 145b. The consumer can interact with the consumer application interface 145b to manage and monitor payments. Back button 325 causes the application program to present the previously shown user interface screen. Also, viewing box 330 presents a live screen to explain information related to payment fulfilment (e.g., “Visit any Kiosk at U-Village (in the next 48 hours) and enter the code below.”). Verification code 335 provides a consumer with a code (e.g., “12334556”) to use at a kiosk to receive a payment. Confirm and cancel buttons 340a-b can be used by consumer to proceed with a transaction (e.g., if consumer pushes confirm, code can be transmitted to a kiosk and a consumer can be prompted to enter the code at the kiosk in order to receive a voucher redeemable for cash).

FIG. 4 illustrates a representative browser interface that allows a consumer to manage and monitor payments from entities. The browser interface can include buttons or other user interface controls (e.g., hyperlink, tile, widget) for providing payment information 400, enabling consumer login 405, managing computing devices 410, managing consumer access 415, providing technical support 425, configuring settings 430, and monitoring current payments 435. The consumer application interface 145b screen can be launched using a web browser (e.g., SAFARI, CHROME, EXPLORER). For example, when using consumer application interface 145b in a web browser, a consumer can sign up for a service (described in this disclosure) that enables a consumer to use computing device(s) to receive a tax refund. Consumer can connect this service to their phone or can use it separately (e.g., through web browsing). Also, consumers can create usernames and passwords for accounting purposes or can remain anonymous. For example, a consumer can prefer to use an email that is not linked to his or her personal information or identity.

### Payment Server

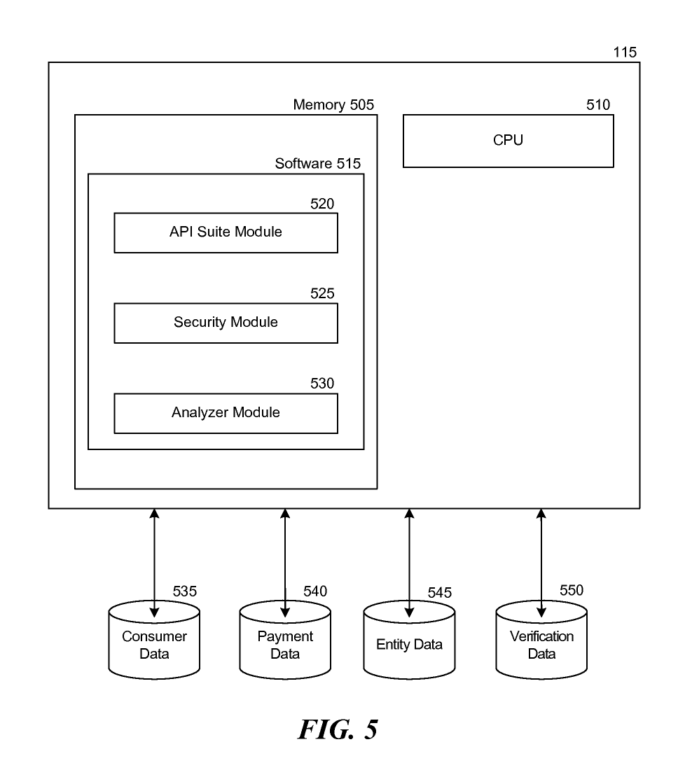

FIG. 5 is a block diagram illustrating elements of the payment server 115 in accordance with one embodiment of the present disclosure. As shown in FIG. 5, the payment server 115 includes memory 505, software 515, and one or more central processing units (CPU) 510 for executing software 515 stored in memory 505.

Memory 505 stores software 515 comprised of one or more modules and data utilized by the modules. The modules perform certain methods or functions of payment server 115 described herein and can include components, subcomponents, or other logical entities that assist with or enable the performance of some or all of these methods or functions. In the embodiment shown on FIG. 5, payment server 115 modules include API suite module 520, security module 525, and analyzer module 530, each of which is described in more detail below.

Generally, API suite module 520 is for software-to-software interfacing, which allows applications (e.g., entity applications) and programs (e.g., entity software) to communicate with payment server 115. API suite module 520 can have one API or several APIs. For example, API suite module 520 can have an API for accessing consumer names (“consumer API”), an API for confirming a payment is complete (“confirm payment API”), an API for determining which kiosk is close to a consumer (“kiosk location API”), and an API for handling verification information (“verification API”). Thus, each API in API suite module 520 can serve a different function (e.g., one API for payment requests, another for location, an API for verifying consumers' identities with an entity, and an API for verifying a payment amount from an entity to consumer). For example, an IRS database or server can call an API in API suite module 520 to request payment to a specific consumer. Also, as another example, an IRS database can call an API in API suite module 520 and request verification that a specific consumer has received a tax refund. APIs can make calls back and forth between applications for payment server 115 and entity servers 130 and entity databases 135, and these calls can be managed through Web services. Web services can include Extensible Markup Language (XML), which is one programming language by which applications communicate over the Internet. Furthermore, API suite module 520 can use Simple Object Access Protocol (SOAP), which is responsible for encoding XML messages so that they can be received and understood by any operating system over any type of network protocol; it also can use Universal Description, Discovery, and Integration (UDDI) as an XML-based directory that allows businesses to list themselves, or it can use Web Services Description Language (WSDL).

Entities can need information to use or access APIs in API suite module 520. For example, an entity can need classes information, function and call information, or encryption information to access and use API suite module 520. Entities can determine what features they want supported. For example, entities can request a map of kiosks (e.g., in order to determine where to pay consumers) or entities can request a list of consumers who are waiting for payment (e.g., calculate the number of consumers requesting a refund and the amount that each consumer is owed). Entities can add a link or window to their webpages. For example, the IRS can have a small window on its webpage where a consumer can make payment requests.

An administrator of payment server 115 can host an API suite module 520 library that provides functionality common to all API suite modules 520 such as classes, functions, calls, Hypertext Transfer Protocol (HTTP) transport, error handling, authentication, parsing, media download/upload, and batching. One with ordinary skill in the art will appreciate that entities can design and write their own APIs, and payment server 115 can call and use each entity API. Furthermore, administrators of payment servers and entities can include security certificates and other security procedures or protocols to ensure safety in the execution of transactions (e.g., payments).

Security module 525 maintains secure and authentic communications between payment server 115, kiosk(s) 110a-n, and entity servers 130 and entity databases 135. Security module 525 can comprise any combination of software agents and/or hardware components to perform such filtering. For example, the IRS can require that before a taxpayer receives a refund at a specific kiosk, the payment server administrator must require two forms of identification to verify a consumer's identity (e.g., driver's license and credit card). Security module 525 can store this information locally, and then can send this information to a kiosk where the consumer can redeem a tax refund. Security module 525 can also implement other features. For example, if a kiosk is configured to read barcodes or verification codes, security module 525 will communicate with entities and merchants to ensure a voucher code is not duplicated or used more than once; rather, security module 525 will identify and authenticate unique voucher codes and deny requests if the voucher or barcode is not correct.

Analyzer module 530 receives, reviews, and responds to queries and requests that come from other modules or components of environment 100. Analyzer module 530 can comprise any combination of software agents and/or hardware components to perform such filtering. In some embodiments, analyzer module 530 transmits location and payment information for consumer(s) 105a-d to one or more kiosk(s) 110a-n. Operation of analyzer module 530 will be described in additional detail with respect to FIGS. 6 and 7.

As shown in FIG. 5, payment server 115 can access many databases, namely consumer data 535, payment data 540, entity data 545, and verification data 550. Consumer data 535, payment data 540, entity data 545, and verification data 550 are accessible by all the modules described above, and the modules can store information in consumer data 535, payment data 540, entity data 545, and verification data 550 or update information in these databases continuously, periodically, or sporadically. Consumer data 535 includes such items as information about consumer(s) 105a-d. For example, consumer data 535 can include contact information, the number of payments pending for a consumer, billing information, identification forms, how long a consumer has used the service, a consumer's username, a consumer's preferred name, biometric information (e.g., height, weight, eye color), and other relevant consumer information. Payment data 540 can include payment information such as amount of payment, when to pay, preferred location and method of payment, fee for paying consumer, currency for paying (e.g., U.S. dollars or other currency), and other relevant payment information. Entity data 545 can include any information related to entities such as the name of the entity or the contact information for the entity. Entity data 545 can also include all outstanding payments needed to be made for an entity. Verification data 550 can include information necessary to verify a consumer's identity or information necessary to verify a payment, which can include driver's license numbers, credit card and debit card numbers, social security numbers, numerical codes, alpha numeric codes, verification challenges and answers, visual and audio clips or data, and other related verification information. Operation of consumer data 535, payment data 540, entity data 545, and verification data 550 will be described in additional detail with respect to FIGS. 6 and 7.

Payment server 115 can receive information that does not include information that directly identifies consumers; rather, the information can include unique codes to identify a consumer. For example, a merchant may not want to provide personal consumer information to payment server 115. Instead, a merchant can provide a list of payment amounts, a list of unique identifiers (e.g., a numeric code for a consumer), and list of emails or phone numbers. Then, payment server 115 can contact each consumer using an email or phone number (instead of a name or social security number), and provide each consumer with the unique code. The consumer can then use this unique code at a kiosk to receive a payment from a merchant.

### Illustrative Flow Diagrams

FIG. 6 is a flow diagram illustrating a process implemented by a payment server in accordance with one embodiment of the disclosed technology. The payment server 115 (as shown in FIG. 1) can implement process 600. In step 610, payment server 115 receives payment information for a consumer from an entity. For example, Recreational Equipment, Inc. (REI), an outdoor retailer calls to a payment API in API suite module 520, and the call can ask payment server 115 to pay consumer “John Doe,” $50. In some embodiments, REI can make another call to verification API in API suite module 520, and REI can request that in order for John Doe to receive the $50, John Doe must present his valid driver's license or a credit card in his name at the kiosk. Payment server 115 can use its processor to execute operations for an API in API suite module 520 to invoke analyzer module 530 to access payment data 540 to store this payment information. The payment information can include the consumer's name, the consumer's email, the amount of money to be paid, an identification code, instructions for payment, required verification information for payment, and other related payment details. In general, step 610 involves an entity sending payment information to the payment server 115, which payment server 115 then can store this information and can execute other steps in response to receiving this payment information. Also, in some embodiments, the request to receive payment from an entity can come directly from a consumer. For example, a consumer can use his or her computing device and one of the interfaces described in FIGS. 3 and 4 to request a payment from an entity. In such an example, the consumer can request to receive the payment from an entity, and the payment server will then query the entity and handle the payment process going forward. In such an example, the payment server 115 can have access to an entity's data or the payment server 115 can use other means (e.g., an API or other communication protocol) to confirm or verify the consumer's request.

In step 615, payment server 115 can determine a kiosk where the consumer can receive a payment. Step 615 is an option step (as shown by the dashed lines in FIG. 6). In some embodiments, a consumer can requests a specific kiosk from kiosk(s) 110a-n to receive a payment. For example, if the consumer has used a kiosk close to his or her house before, and the consumer has saved this kiosk location to the payment server (e.g., saved the kiosk location to a user account), then the payment sever 115 can determine to use this specific kiosk for paying the consumer. In some embodiments, payment server 115 can invoke analyzer module 530 to determine an optimal kiosk in the network of kiosks for payment delivery. Payment server 115 can determine the optimal kiosk based on the consumer's location, the time at which the consumer is willing to receive the voucher or payment, or the capability of the kiosks in the network. For example, payment server 115 can use traffic conditions, distance from consumer to kiosk, and time of day to determine a kiosk that will be easily accessible to the consumer. Payment server 115 can have traffic and location information stored in consumer data 535 or it can query well known databases (e.g., GOOGLEMAPS); also, payment server 115 can gather this information from a consumer if the consumer is using a mobile application to receive payments. In some embodiments, one kiosk in the kiosks 110a-n can receive a request from a consumer, and that kiosk can query the payment server 115 to further proceed with paying the consumer.

Furthermore, entity servers 130 can determine which kiosks a consumer can use to receive a payment, and the entities can communicate the determined kiosks to payment server 115. For example, an entity can instruct payment server 115 (e.g., inform an administrator of the server) that an entity wants consumer(s) 105a-d to use only one kiosk. For example, for security purposes, a small business can prefer consumers use a kiosk in a location near the small business. In another example, an entity can determine that it wants consumer(s) 105a-d to be able to receive payments at any kiosk (e.g., kiosks around the world). Payment server 115 can store these preferences in entity data 545. In some embodiments, a consumer can determine a kiosk for receiving a payment.

In step 620, payment server 115 sends a notification to the consumer. In some embodiments, the notification can include instructions for receiving the payment (e.g., instructions to download a mobile application that assists consumers in receiving payments, a text message with instructions, or an email with directions for receiving a payment). In some embodiments, the notification can include a code, which the consumer can use for verification to receive the payment. In some embodiments, the notification can include a specific kiosk and/or kiosk location where the consumer should receive the payment. In some embodiments, the notification can inform the consumer that the consumer can visit any kiosk to receive a payment or redeemable voucher. In some embodiments, the notification can be a text message with a hyperlink, which includes instructions for how the consumer can receive the payment. Payment server 115 can also send a notification to an application or interface as described in FIGS. 3 and 4. The consumer can view notifications from payment server 115 via consumer applications or interfaces as described in FIGS. 3 and 4. In some embodiments, if the consumer directly requested the payment from the payment server, then payment server can alter its notification to show the entity has confirmed the payment.

In step 625, payment server 115 can receive a response to the notification. Step 625 is an optional step (indicated by the dashed lines in FIG. 6). In the response, a consumer can include a query asking payment server 115 for a list of kiosk(s) 110a-n close to his or her location or close to a preferred address. A response can indicate the time a consumer desires to pick up the payment or voucher. Consumer(s) can also decline a request to receive a payment. Consumer(s) can use computing devices 120a-b to create the response, or consumers can directly contact payment server 115 using an interface described in FIGS. 3 and 4. One with ordinary skill in art will appreciate that a consumer might not respond to payment notification, but instead, a consumer can report to a kiosk. In these cases, a kiosk can directly communicate with the consumer and payment server 115 to determine if the consumer can receive a payment at this kiosk.

In step 630, payment server 115 receives a request for authorization to pay the consumer via a kiosk. In some embodiments, a request can ask payment server 115 to verify a payment to a specific consumer. For example, the request can ask the payment server to verify that John is supposed to receive $55 from REI. In some embodiments, a request can ask payment server 115 if the consumer provided the correct verification information (e.g., photo ID, code, answer to verification challenges). For example, if John input his credit card information and his driver's license for verification purposes, then the request can ask payment server 115 if this information is correct. Payment sever 115 can query consumer data 535, payment data 540, entity data 545, and/or verification data 550 in response to this request. In some embodiments, in response to the request, payment server 115 can also send instructional information (not shown in FIG. 6) such as whether the payment is via cash or voucher, and what to do if the consumer refuses to accept or cancels the payment (e.g., notify the consumer that this is a one-time offer or that he can return again at another time). Payment server 115 can also send additional security and/or verification information or requests to the kiosk.

In some embodiments, receiving a request for authorization can include receiving a request from identification system 225 via the kiosk. For example, a consumer can insert his or her driver's license into identification system 225, and the request can ask to verify if identification is valid (e.g., neither an expired nor a fake ID) or proper (e.g., the correct person). Also, in some embodiments, the kiosk and payment server can implement an iterative process (e.g., ask for photo ID, respond that the ID is correct, ask for credit card information, verify it is correct, ask for code, verify it is correct). In some embodiments, verification can occur locally (e.g., at kiosk) or remotely (e.g., at payment server). For example, kiosk 110a can receive a credit card number from consumer 105a who wishes to receive a payment. In response to receiving the credit card number, kiosk 110a can query verification module 240 (locally), and verification module can verify that the credit card information matches the consumer's profile. Alternatively, a kiosk can query payment information to determine that the credit card number is proper verification for the payment. In response, payment server 115 can communicate validation of the credit card number to kiosk 110a.

In step 635, payment server 115 sends authorization for payment of the consumer via the kiosk. In some embodiments, payment server 115 can query consumer data 535, payment data 540, entity data 545, and/or verification data 550 to authorize the payment to the consumer. For example, payment server 115 can verify that another kiosk has not already paid the consumer, that the consumer's identity and/or the code for authorization are valid, the entity has not placed a stop payment request, etc. Payment server 115 can perform other operations that an entity requires for proper payment. In step 640, an optional step, the payment server 115 can notify the entity that requested to pay the consumer that the kiosk has received authorization to pay the consumer. In some embodiments, payment server 115 can transmit other relevant payment information such as when the payment was requested, how long the payment process took (e.g., did the consumer spend more than one minute requesting the payment). In some embodiments, the payment server 115 can also relay information from the consumer to the entity regarding the payment service (e.g., whether it was a satisfactory experience or whether the consumer has any other customer service requests).

Ultimately, the process described in FIG. 6 can be customized depending on the entity's preferences, consumer preferences, and the host of payment server. Also, the process can be customized depending on if the consumer initiated the request or the entity initiated the request. The payment server can also include operations for handling the payment locally (e.g., required verification information and payment amount).

FIG. 7 is a flow diagram of operations 700 performed by a kiosk interacting with a consumer for payment fulfilment. In some embodiments, the kiosk(s) can receive consumer or payment information before a consumer requests payment at a kiosk. For example, payment server 115 (as shown in FIGS. 1 and 5) can send kiosk(s) 110a-n (e.g., one kiosk or several kiosks) a list of consumer(s) 105a-d who are using or planning to receive payments from entities, and payment server 115 can include security information such as when the payment is permitted to be paid (e.g., a waiting period or an expiration date) and the form of payment (e.g., a voucher, cash, or credit in an electronic wallet). Payment server 115 can send financial and security information to one kiosk (“a determined kiosk”) or several kiosks (including all kiosks in the network).

In step 710, a kiosk receives a request for payment. For payment requests, kiosk(s) 110a-n can receive inputs from kiosk user interface 205, input area 210, identification system 225, audio or visual signals from consumer(s) 105a-d, or from consumer's computing device(s) 120a-b. For example, consumer 105a can enter his or her name or login credentials at kiosk user interface 205 and then request a payment. Also, without being prompted, a consumer can slide his or her credit card in identification system 225, and the kiosk can assume the consumer is requesting a payment. In some embodiments, kiosk user interface 205 prompts consumer(s) 105a-d with certain questions (e.g. “What do you need?”, “Are you here to receive a payment?”), and consumer(s) 105a-d input a response using the kiosk user interface 205 or input area 210. Consumers can also speak to kiosk(s) 110a-n or demonstrate visual signals. For example, when kiosk 110a is equipped with a microphone and speaker, communication module 235 can ask consumer 105a certain questions (“What do you need?”), and consumer 105a can respond to the questions. Additionally, kiosk(s) 110a-n can be equipped with a video camera and/or motion detection device (not shown in FIG. 2). A consumer can respond to questions from a kiosk in kiosk(s) 110a-n with hand motions or movements. For example, if kiosk 110a recognizes a consumer's face using facial recognition software, kiosk 110a can ask consumer 105a “Do you want to receive your tax refund from the IRS?”. In response, consumer 105a can nod his or her head, and kiosk 110a will detect this head movement and interpret it as an affirmative response.

In some embodiments, the kiosk presents a user interface to a consumer, which prompts the consumer to make a payment request. In such embodiments, kiosk user interface 205 can display questions or interactive buttons. A consumer 105a can respond to the questions or select certain buttons. Also, kiosk user interface 205 can display a screen prompting a consumer to enter identification information (e.g., driver's license number or verification code). Consumer(s) can also use kiosk user interface 205 to query payment server 115. For example, a consumer can push a button on kiosk user interface 205, and the button can allow a consumer to view all pending payments or transactions. One with ordinary skill in the art will appreciate that consumer(s) can use near field communication (NFC) and a computing device screen (e.g. a mobile phone) instead of kiosk user interface 205 to interact with kiosk(s) 110a-n. Consumer(s) can also use input area 210 to type letters, numbers, or other characters. Consumer(s) can use kiosk user interface 205 and input area 210 to enter information or respond to questions from kiosk(s) 110a-n.

In step 720, a kiosk receives identification information from the consumer. In some embodiments, the kiosk can prompt the consumer to provide identification information before, during, or after the consumer requests a payment. The kiosk can request various forms of identification such as photo ID, a unique code, credit card, debit card, username, and the like. Consumer(s) 105a-d can identify himself or herself using identification system 225. For example, if kiosk 110a notifies consumer 105a that a payment is waiting for consumer 105a via kiosk user interface 205, in order for consumer 105a to receive payment, consumer must first verify his or her identity. To verify his or her identity, a consumer 105a, when prompted or arbitrarily, can insert his or her driver's license or credit card into the identification system 225. Other forms of identification information can be used as discussed above including a challenge and response protocol or a unique identification code.

In step 730, a kiosk determines whether the consumer is authorized to receive payment. Depending on how an administrator wants to set up the disclosed system, verification can happen locally or globally. In some embodiments, a kiosk can be able to locally determine whether a consumer is authorized to receive payment because payment server 115 can send consumer information, verification information, and required identification information to the kiosk before a consumer attempts to fulfill payment. In other embodiments, consumer(s) 105a-d can request to receive payment from a kiosk in kiosk(s) 110a-n, or a kiosk can wait for consumer(s) to enter verification information without the kiosk having information regarding the payment. In these embodiments, kiosk(s) must query payment server 115 to verify identification of consumer(s) or payment information, and kiosk(s) must receive authorization from payment server 115 or receive further instructions from payment server 115.

In step 740, a kiosk dispenses payment to the consumer. For example, voucher module 245 will send instructions to receipt/voucher printer and dispenser 215 or cash dispenser 230, and the instructions will include a computer-readable code for printing a redeemable voucher or instructions for dispensing cash. The consumer can receive the cash or receive the redeemable voucher. If the voucher has limits on it (e.g., it can only be used for a certain time period or with a certain merchant, then this information will be printed on the voucher). The consumer can redeem the voucher at a merchant. For example, if a consumer received a voucher from a merchant for a credit refund for $35, the consumer can walk to a cashier in a supermarket (the kiosk is located in the supermarket), and ask the cashier to cash the voucher. In some embodiments, the kiosk can prompt the consumer via the user interface, and the prompt can ask the consumer to confirm he or she has received the payment. This confirmation can be sent to the payment server.

From the foregoing, it will be appreciated that specific embodiments of the invention have been described herein for purposes of illustration, but that various modifications can be made without deviating from the scope of the invention. Accordingly, the invention is not limited except as by the appended claims.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus.

A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium also can be, or can be included in, one or more separate physical components or media (e.g., multiple CDs, disks, or other storage devices). The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example programmable processor(s), computer(s), system(s) on a chip, or multiple ones, or combinations, of the foregoing. The apparatus can include special purpose logic circuitry, e.g., an FPGA (field programmable gate array) or an ASIC (application specific integrated circuit). The apparatus also can include, in addition to hardware, code that creates an execution environment for the computer program in question, for example, code that constitutes processor firmware, protocol stack(s), database management system(s), operating system(s), cross-platform runtime environment(s), virtual machine(s), or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program can, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Also, devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM discs. The processor and the memory can be supplemented by, or incorporated in, special purpose logic circuitry.

To provide for interaction with a user, embodiments of the subject matter described in this specification can be implemented on a computing device having an interface. An interface can be a display device, e.g., an LCD (liquid crystal display), LED (light emitting diode), or OLED (organic light emitting diode) monitor, for displaying information to the user and a keyboard and a pointing device, e.g., a mouse or a trackball, by which the user can provide input to the computer. In some implementations, a touch screen can be used to display information and to receive input from a user. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

In general, the detailed description of embodiments of the described technology is not intended to be exhaustive or to limit the technology to the precise form disclosed above. While specific embodiments of, and examples for, the technology are described above for illustrative purposes, various equivalent modifications are possible within the scope of the described technology, as those skilled in the relevant art will recognize. For example, while processes, blocks, and/or components are presented in a given order, alternative embodiments can perform routines having steps, or employ systems having blocks, in a different order, and some processes or blocks can be deleted, moved, added, subdivided, combined, and/or modified. Each of these processes, blocks, and/or components can be implemented in a variety of different ways. Also, while processes, blocks, and/or components are at times shown as being performed in series, these processes, blocks, and/or components can instead be performed in parallel, or can be performed at different times.

As used herein, the word “or” refers to any possible permutation of a set of items. For example, the phrase “A, B, or C” refers to at least one of A, B, C, or any combination thereof, such as, any of: A; B; C; A and B; A and C; B and C; A, B, and C; or multiples of any item such as A and A; B, B, and C; A, A, B, C, and C; etc.

The teachings of the described technology provided herein can be applied to other systems, not necessarily the system described herein. The elements and acts of the various embodiments described herein can be combined to provide further embodiments.

I/We claim:

1. A networked computer system configured to fulfill a payment to a consumer, the networked computer system comprising:
a processor; and
a memory storing a first set of instructions to be executed by the processor to:
receive, from an entity, a request to make a payment to the consumer;
send an electronic notification to the consumer,
wherein the electronic notification includes a second set of instructions for the consumer to receive the payment;
receive a response communication from the consumer;
receive a request from a kiosk for authorization to dispense payment to the consumer; and
transmit a response to the kiosk,
wherein the response includes authorizing payment to the consumer.

2. The networked computer system of claim 1, wherein the response to the kiosk includes a third set of instructions that the consumer must provide verification information before receiving the payment.

3. The networked computer system of claim 1, wherein the electronic notification to the consumer is an email, text message, or notification for a mobile application.

4. The networked computer system of claim 1, wherein the first set of instructions include: determine a kiosk from a network of kiosks to include in the electronic notification to the consumer.

5. The networked computer system of claim 1, wherein the kiosk is capable of dispensing cash or printing a redeemable voucher for the payment to the consumer.

6. The networked computer system of claim 1, wherein the request from the kiosk includes verification information, wherein the verification information includes one or more of:
a password;
a username;
a credit card number;
a numerical code; or
photo identification.

7. The networked computer system of claim 1, wherein the first set of instructions include:
receive a confirmation that the consumer received a cash payment or a redeemable voucher; and
send a message to the entity that sent the request to pay a consumer, wherein the message includes the confirmation that the consumer received the cash payment or the redeemable voucher.

8. A consumer-operated system for providing a payment to a consumer, the consumer-operated system comprising:
a memory;
an interface configured to receive input from a consumer and to display information to the consumer;
a processor disposed in communication with the memory and configured to execute instructions stored in the memory to:
receive, via the interface, a request from the consumer for payment from an entity;
request, via the interface, that the consumer provide verification information;
receive the verification information from the consumer;
send a request to a payment server for authorization to pay the consumer, wherein the request includes at least partial verification information;
receive authorization from the payment server to dispense payment to the consumer; and
dispense cash or a voucher to the consumer.

9. The consumer-operated system of claim 8, wherein the verification information is a unique code.

10. The consumer-operated system of claim 8, further comprising:
an identification receiver configured to receive one of more of: a photo identification, a credit card, a debit card, an audio signal, a visual signal, a bar code, a QR code, or a communication from a mobile device.

11. The consumer-operated system of claim 8, wherein determining that the verification information is valid includes using a communication network to query a verification database.

12. The consumer-operated system of claim 8, wherein determining that the verification information is valid includes querying a locally accessible database.

13. The consumer-operated system of claim 8, wherein the interface is a touchscreen.

14. A consumer-operated kiosk system for fulfilling a payment to a consumer, the consumer-operated kiosk system comprising:
a consumer-operated kiosk configured to communicate with a remote database,
wherein the remote database includes information related to payments from at least one entity to the consumer,
wherein the consumer-operated kiosk includes:
means for receiving consumer identification information; and
a communications facility configured to:
communicate with the remote database to retrieve payment information associated with a consumer in response to receiving at least a request to fulfill a payment to the consumer, and
initiate payment to the consumer of at least a portion of funds received at the consumer-operated kiosk.

15. The consumer-operated kiosk system of claim 14, further comprising:
means for challenging the consumer to verify his or her identity; and
means for receiving a response from the challenge.

16. A computer-readable medium, excluding transitory signals, storing instructions that when executed by one or more processors cause a machine to perform a method for fulfilling a payment to a consumer, by:
receiving a notification to pay a consumer;
receiving an amount of currency to pay the consumer;
receiving verification required for paying the consumer;
receiving, via an interface, input from the consumer to receive the amount of currency;
providing, via an interface, a verification challenge to the consumer;
receiving, via an interface, a response to the verification challenge from the consumer;
determining that the response to the verification challenge is valid; and
dispensing the amount of currency to pay the consumer or printing a voucher, wherein the voucher is redeemable for the amount of currency.

17. The computer-readable medium of claim 16, wherein the verification challenge is a series of questions, and
wherein the series of questions has specific pre-determined answers.

18. The computer-readable medium of claim 16, wherein the verification challenge inquires about one or more of: a photo identification, credit card, debit card, audio or visual signal from the consumer, or mobile device phone number.

19. The computer-readable medium of claim 16, wherein determining that the response to the verification challenge is valid further comprises:
querying a remote database that stores verification challenge and response information.

20. The computer-readable medium of claim 16, wherein determining that the response to the verification challenge is valid further comprises:
querying a local database that stores verification challenge and response information.
